(19) United States
(12) Patent Application Publication
(10) Pub. No.: US 2023/0152651 A1
(43) Pub. Date: May 18, 2023

(54) A MULTI-LAYER ASSEMBLY FOR PROVIDING A TARGETTED TRANSMITTED COLOR AND TARGETTED REFLECTIVE COLOR

(71) Applicant: SOLUTIA CANADA INC., VANCOUVER (CA)

(72) Inventors: JONATHAN ROSS SARGENT, VANCOUVER (CA); BRODERICK W. ALBRIGHT, BURNABY (CA); TOM ROWE, BURNABY (CA); VERONICA ELIZABETH MARSHMAN, PORT MOODY (CA); JEREMY GRAHAM FINDEN, NORTH VANCOUVER (CA)

(73) Assignee: SOLUTIA CANADA INC., VANCOUVER, BC (CA)

(21) Appl. No.: 17/920,466

(22) PCT Filed: Apr. 23, 2021
(86) PCT No.: PCT/CA2021/050558

§ 371 Date: Oct. 21, 2022

Related U.S. Application Data
(60) Provisional application No. 63/015,048, filed on Apr. 24, 2020.

(51) Int. Cl. G02F 1/157; G02F 1/163; C09D 161/02

(52) U.S. Cl. CPC G02F 1/157; G02F 1/163; C09D 161/02; G02F 2203/48; G02F 2202/14; B60J 3/04

(57) ABSTRACT

Layered assemblies are disclosed, that include a variable transmittance layer having opposing first and second sides; at least a first reflectance color-balancing layer positioned on the first side of the variable transmittance layer; and a transmittance color-balancing layer positioned on the first side or the second side of the variable transmittance layer. The variable transmittance layer may be variable between a dark state and a light state, and may have a dark state transmittance spectrum when in the dark state and a different light state transmittance spectrum when in the light state.

### TECHNICAL FIELD

The present disclosure relates generally to layered assemblies that are variable transmittance filters. The assemblies are also designed to show an optimal reflective color. The assemblies may include one or more coatings.

### BACKGROUND

A variable transmittance window permits the electromagnetic radiation that is transmitted through the window to be selectively filtered. For example, when incorporated into a vehicle, such as the vehicle's sunroof or passenger windows, one or both of the intensity and wavelength of the electromagnetic radiation that enters and exits the vehicle via variable transmittance windows can be controlled to influence parameters such as the intensity of light within the vehicle.

Some prior art in the field includes Guardian Glass WO2018075005A1 or US20190248700A1, which describes a gray colored coated article with low-e coating having absorber layer and low visible transmission. Also from Guardian Glass, US20170267579A1 and U.S. Ser. No. 10/247,855 describe a gray colored heat treatable coating article having low solar factor value. U.S. Pat. No. 9,588,358 from SWITCH Materials Inc. describes an optical filter comprising a variable transmittance layer that addresses achieving a target transmitted color.

Variable transmittance optical filters may employ a variety of technologies to alter visible light transmittance. Generally, such filters may be switched between a state of higher light transmittance (faded or light state) to a state of lower light transmittance (dark state) with the application, removal or reduction of a stimulus such as UV light, temperature and/or a voltage. Examples of technology used in variable transmission windows include photochromics, electrochromics, thermochromics, chemochromics, piezochromics, liquid crystals, or suspended particles. Some photochromic materials may darken in response to light, for example ultraviolet light, and may return to a faded state when the UV light is removed or reduced. Some electrochromic materials may darken in response to application of a voltage, and may return to a faded state once the voltage is removed; alternately, some electrochromic materials may darken in response to application of a voltage of a first polarity, and fade when a voltage of an opposite polarity is applied. Some thermochromic materials may darken proportionately in response to a temperature increase—for example, the warmer the material, the darker it can become. The thermochromic material may return to a faded state when the temperature decreases. Some chemochromic materials may darken or lighten in response to chemical changes in the environment, such as hydrogen gas, pH, or ion concentration. Some piezoelectric materials may darken or lighten in response to pressure changes or changes in mechanical stress. Liquid crystal materials and suspended particle devices comprise crystals or particles that alter orientation in response to application of a voltage. In the absence of a voltage, the crystals or particles are randomly oriented, and scatter incident light, thus appearing opaque, or transmit very little light. When a voltage is applied, the crystals or particles are aligned with the electric field, and light may be transmitted. Where the variable transmittance optical filter includes an electrochromic aspect, the variable transmittance optical filter may comprise electrical connectors for connecting the optical filter to a control circuit, the control circuit to provide power to the optical filter to effect an electrochromic color change.

Depending on the nature of the variable transmittance optical filter and its use, further attenuation of the transmitted light or solar energy may be desirable. Where the variable transmittance optical filter is used on the window of a vehicle, aircraft or building, reducing or blocking transmission of infrared light may be useful to control the heat gain, and reducing or blocking transmission of ultraviolet light may be useful to protect occupants in the vehicle or building. Where impact protection is desirable, inclusion of laminated glass (“safety glass”) in the window may be useful.

Laminated glass with a neutral or gray transmissive color that concomitantly demonstrates a neutral or gray reflective color is known—US20170267579A1 and WO2018075005A1 describe a coated article that is designed so that the article realizes gray glass side reflective coloration in combination with a low solar factor and/or a low solar heat gain coefficient. These applications do not, however, address how the color may be manipulated in a window with variable light transmission in the visible range.

Laminated glass with a tint or coloring are known—U.S. Pat. No. 4,244,997 and US 2009/0303581 describe a laminated glass with a shade band and U.S. Pat. No. 7,655,314 describes a laminated glass with an interlayer comprising an IR blocking component, and a coloring agent to complement the yellow-green appearance of the IR blocking component, but does not address how the color may be manipulated in a window with variable light transmission in the visible range. Tinted glass in gray, bronze or green tones may also be used to attenuate the light transmitted through a window. Some tints may attenuate light approximately equally across the visible spectrum, and while this may be effective in reducing the overall glare, it may not provide for color “correction” to a neutral tone if a component of the laminated glass itself has a color, and additional color correction may be needed.

Where the laminated glass has a variable transmittance component, the degree of light transmission in one or both of the faded and dark states may be too great, or of a distorted color. It is difficult to tandemly balance the transmitted color (e.g. the color of the laminated assembly where the eye is observing the light passing through said assembly) to a desirable neutral color, while achieving a likewise neutral color for the reflected light (e.g. the color of the laminated assembly where the eye is observing the light being reflected). Previously, color balancing of glazing products such as automotive sunroofs and architectural windows was accomplished by altering the chemical composition of the glass itself to provide the desired color, or by including a colored interlayer (e.g. PVB) in between two sheets of glass. Altering the color of the variable transmittance filter is much more difficult because the materials used for producing the variable transmittance cannot easily be changed to different colors while maintaining all of the variable transmittance properties. For example, some variable transmittance filters are blue in color, which may be suitable for some applications but not others. Currently, the color of the overall product is determined by the color of the variable transmittance filter, even if that color is not seen as the most desirable by customers and potential customers of the product. Inclusion of one or more additional visible light filters may further attenuate the transmitted light, but may also distort the color or exacerbate an already distorted color.

U.S. Pat. No. 9,588,358 describes an optical filter comprising a variable transmittance layer having a first spectrum in a dark state, and a second spectrum in a faded state, and a color-balancing layer having a third spectrum. When the dark state spectrum is combined with the spectrum of the color-balancing layer, the resulting transmitted spectrum approximates a dark state target color. Similarly, the light state spectrum combines with the color-balancing layer such that the resulting transmitted spectrum approximates a target light state color. U.S. Pat. No. 9,588,358 does not provide any teaching or guidance for how to optimize the reflected color of the optical filter. Additional light attenuating layers may be included in the stack, and the optical filter may comprise part of a laminated glass.

### SUMMARY

In one aspect, the invention relates to layered assemblies that include a variable transmittance layer having opposing first and second sides; at least a first reflectance color-balancing layer positioned on the first side of the variable transmittance layer; and a transmittance color-balancing layer positioned on the first side or the second side of the variable transmittance layer. The layered assemblies of the invention may further include a second reflectance color-balancing layer on a side of the variable transmittance layer opposite the first reflectance color-balancing layer.

In another aspect, the invention relates to a multi-layer composition comprising a variable transmittance optical filter layer and one or more color-balancing layers selected to combine with the color of the variable transmittance optical filter in order to achieve a desired transmitted color and a desired reflective color. A laminated glass window with variable light transmittance that provides both a target (e.g., neutral) transmitted color in a faded state, a dark state, or both a faded and dark state, while tandemly providing a target (e.g. neutral) reflective color in a faded state, a dark state, or both a faded and dark state, represents a useful addition over the art, and may be used in automotive windows (windshields, sunroofs, moonroofs, windows, backlites, sidelites or the like), other transportation applications such as trains and buses, architectural applications, eyewear and ophthalmic devices or applications, or the like.

Other aspects are as further disclosed and claimed herein.

### BRIEF DESCRIPTION OF THE DRAWINGS

These and other features will become more apparent from the following description in which reference is made to the appended drawings. The figures are for illustrative purposes, and unless indicated otherwise, may not show relative proportion or scale.

FIG. 1 shows a sectional view of a laminated assembly according to one embodiment.

FIG. 2 shows a sectional view of a laminated assembly according to another embodiment.

FIG. 3 shows an exploded schematic view of a laminated assembly, portraying decreasing levels of light transmission and reflection, with added color-balancing layers.

FIG. 4 shows a color-balancing layer in the form of a layer-by-layer composite coating.

FIG. 5 shows a color-balancing layer in the form of a layer-by-layer composite coating.

FIG. 6 shows a monotone L*a*b* color wheel with target transmitted color ranges with a variable transmittance layer in the dark state.

FIG. 7 shows a monotone L*a*b* color wheel with target transmitted color ranges with a variable transmittance layer in the light state.

FIG. 8 shows a monotone L*a*b* color wheel with target reflected color ranges with a variable transmittance layer in the dark state.

FIG. 9 shows a monotone L*a*b* color wheel with target reflected color ranges with a variable transmittance layer in the light state.

### DETAILED DESCRIPTION

In one aspect, the invention thus relates to a layered assembly that includes a variable transmittance layer having opposing first and second sides; a reflectance color-balancing layer positioned on the first side of the variable transmittance layer; and a transmittance color-balancing layer positioned on the first side or second side of the variable transmittance layer. The layered assembly may further comprise a second reflectance color-balancing layer on a side of the variable transmittance layer opposite the first reflectance color-balancing layer. At least one of the first reflectance color-balancing layer and the transmittance color-balancing layer may comprise, for example, a colored polymer or a plurality of colored films.

As defined herein, the descriptions of transmittance and reflectance are intended to encompass transmittance and reflectance in either direction, or in both directions. One skilled in the art would readily comprehend that it is not necessary for the practice of the invention that the layered assembly satisfy every part of the description of the invention from both directions.

In one aspect, the layered assembly of the invention may further comprise a first polymer layer such as PVB on a first side of the layered assembly, and a second polymer layer such as PVB on a second side of the layered assembly. In another aspect, at least one of the first and second polymer layers comprises a PVB coating on PET. In a further aspect, the layered assembly may further comprise an IR-blocking layer.

In another aspect, the layered assembly of the invention may comprise a polymer-based layer within which the variable transmittance layer, the reflectance color-balancing layer, and the transmittance color-balancing layer are laminated, wherein the reflectance color-balancing layer may be immediately adjacent the polymer-based layer.

The layered assembly may further include panes of glass or other rigid substrates respectively laminated to opposing sides of the polymer-based layer, or to opposing sides of the polymer-based layer, as the case may be.

In various aspects, the variable transmittance layer may be variable between a dark state and a light state; the variable transmittance layer may have a dark state transmittance spectrum when in the dark state and a different light state transmittance spectrum when in the light state; and the dark state transmittance spectrum and transmittance spectra for the color-balancing layers are selected such that in response to visible light incident on the reflectance color-balancing layer when the variable transmittance layer is in the dark state, a transmitted color of the layered assembly approximates a target transmittance color, and a reflected color of the layered assembly approximates a target reflected color; and the variable transmittance layer is preferably not opaque.

In other aspects, the variable transmittance layer is variable between a dark state and a light state; the variable transmittance layer has a dark state transmittance spectrum when in the dark state and a different light state transmittance spectrum when in the light state; and the light state transmittance spectrum and transmittance spectra for the color-balancing layers are selected such that in response to visible light incident on the reflectance color-balancing layer when the variable transmittance layer is in the light state, a transmitted color of the layered assembly approximates a target transmittance color, and a reflected color of the layered assembly approximates a target reflected color.

In certain aspects, the reflectance color-balancing layer may be in or directly underneath the outside glass layer. In other aspects, the target transmitted color and the target reflected color are approximately neutral.

Thus, the target transmitted color in the dark state may have an a* value of between −13 and +13 and a b* value of between −20 and +3, or an a* value of between −10 and +10 and a b* value of between −15 and +3, or an a* value of between −4 and +4 and a b* value of between −7 and +3. Further, the target transmitted color in the light state may have an a* value of between −6 and +10 and a b* value of between −4 and +24, or an a* value of between −5 and +8 and a b* value of between −3 and +18, or an a* value of between −4 and +4 and a b* value of between −2 and +8. According to the invention, the target reflected color in the dark state may have an a* value of −10 to +22 and a b* value of −9 to +9, or an a* value of −4 to +19 and an b* value of −5 to +6, or an a* value of −2 to +15, and a b* value of −2 to +6. Further, the target reflected color in the light state may have an a* value of −10 to +23 and a b* value of −2 to +22, or an a* value of −6 to +18 and an b* value of −2 to +16, or an a* value of −2 to +16, and a b* value of −2 to +12.

In aspects, the actual transmitted color compared with the color in the absence of the color-balancing layers may have a delta C of 20 or less, or 15 or less, or at least 5, or at least 10 and the actual reflected color compared with the color in the absence of the color-balancing layers also has a delta C of 20 or less, or 15 or less, or at least 5, or at least 10.

In aspects, the variable transmittance layer may be photochromic, electrochromic, thermochromic, a liquid crystal material, chemochromic, piezochromic, a suspended particle device, or any combination thereof. In aspects, the variable transmittance layer comprises a photochromic/electrochromic switching material.

In aspects, the variable transmittance layer may be transitionable from a faded state to a dark state when exposed to electromagnetic radiation, and from a dark state to a faded state with the application of a voltage.

In aspects, the layered assembly may have an LT_{A} of less than about 1%, or less than about 2% or less than about 5%, or less than about 10% in a dark state. In aspects, the layered assembly may have an LT_{A} of greater than about 5% or greater than about 10% or greater than about 15% or greater than about 20% in the faded state. In aspects, the transmission haze through the layered assembly is 5% or less, 3% or less, 2% or less, or 1% or less.

In some aspects, at least one of the reflectance color-balancing layer and the transmittance color-balancing layer comprises a layer-by-layer optical product that includes a polymeric substrate and a composite coating, the composite coating comprising a first layer comprising a polyionic binder and a second layer comprising an electromagnetic energy-absorbing insoluble particle, wherein each of said first layer and said second layer include a binding group component which together form a complimentary binding group pair. In these aspects, the composite coating has a total thickness of 5 nm to 300 nm. The first layer may be immediately adjacent to said polymeric substrate at its first face and said second layer is immediately adjacent to said first layer at its opposite face. The electromagnetic energy-absorbing particle may include a particulate pigment, the surface of which includes said binding group component of said second layer. In certain aspects, the layered assembly may further comprise a second composite coating, said second composite coating comprises a first layer comprising a polyionic binder and a second layer comprising an electromagnetic energy-absorbing particle, wherein said first layer of said second composite coating and said second layer of said second composite coating, comprise a complimentary binding group pair. In certain aspects, the second layer of said first composite coating and said second layer of said second composite coating in combination provide an additive effect on the electromagnetic energy-absorbing character and effect of the electromagnetic energy-absorbing optical product. In certain aspects, the polymeric substrate may be a polyethylene terephthalate film and may further comprise an ultraviolet absorbing material. In aspects, the polymeric substrate may be an undyed transparent polyethylene terephthalate film. In aspects, the electromagnetic energy-absorbing particle of said second layer of said first composite coating and wherein said electromagnetic energy-absorbing particle of said second layer of said second composite coating each comprise a pigment. In aspects, the electromagnetic energy-absorbing particle of said second layer of said first composite coating and said electromagnetic energy-absorbing particle of said second layer of said second composite coating provide an additive effect on the visually perceived color of said optical product. These layers may be formed from an aqueous solution.

In an aspect, the layer-by-layer optical products of the layered assemblies may be formed by a process comprising: applying a first coating composition to a polymeric substrate to form a first layer, said composition comprising a polyionic binder; and applying a second coating composition atop said first layer to form a second layer, said second coating composition comprising at least one pigment; wherein each of said first layer and said second layer include a binding group component which together form a complimentary binding group pair. As noted, the electromagnetic energy-absorbing particle may be a pigment and the surface of the pigment may include said binding group component of said second layer. Further, at least one of said first coating composition and said second coating composition may be an aqueous dispersion or solution. The applying steps a) and b) just described are typically performed at ambient temperature and pressure.

In another aspect, the invention relates to a layered assembly that includes a variable transmittance layer having opposing first and second sides; a transmittance color-balancing layer positioned on the first side of the variable transmittance layer; a first reflectance color-balancing layer positioned on the first side of the variable transmittance layer and outboard the transmittance color-balancing layer; and a second reflectance color-balancing layer positioned on the second side of the variable transmittance layer. The invention may further comprise a polymer-based layer within which the variable transmittance layer, the reflectance color-balancing layers, and the transmittance color-balancing layer are laminated, wherein the reflectance color-balancing layer may be immediately adjacent the polymer-based layer. The invention may further comprise panes of glass or other rigid substrate such as polycarbonate respectively laminated to opposing sides of the polymer-based layer.

In aspects, the variable transmittance layer may be variable between a dark state and a light state; the variable transmittance layer may have a dark state transmittance spectrum when in the dark state and a different light state transmittance spectrum when in the light state; and the dark state transmittance spectrum and transmittance spectra for the color-balancing layers are selected such that in response to visible light incident on the reflectance color-balancing layer when the variable transmittance layer is in the dark state, a transmitted color of the layered assembly has an a* value of between −13 and +13 and a b* value of between −20 and +3.

In another aspect, the variable transmittance layer may be variable between a dark state and a light state; the variable transmittance layer may have a dark state transmittance spectrum when in the dark state and a different light state transmittance spectrum when in the light state; and the light state transmittance spectrum and transmittance spectra for the color-balancing layers are selected such that in response to visible light incident on the reflectance color-balancing layer when the variable transmittance layer is in the light state, a transmitted color of the layered assembly has an a* value of between −6 and +10 and a b* value of between −4 and +24, or an a* value of between −5 and +8 and a b* value of between −3 and +18, or an a* value of between −4 and +4 and a b* value of between −2 and +8.

In aspects, the transmitted color may have an a* value of between −10 and +10, and a b* value of between −15 and +3, or the transmitted color may have an a* value of between −4 and +4 and a b* value of between −7 and +3.

In aspects, the variable transmittance layer may be variable between a non-opaque dark state and a light state; the variable transmittance layer may have a dark state transmittance spectrum when in the dark state and a different light state transmittance spectrum when in the light state; and the light state transmittance spectrum and transmittance spectra for the color-balancing layers are selected such that in response to visible light incident on the reflectance color-balancing layer when the variable transmittance layer is in the light state, a transmitted color of the layered assembly has an a* value of between −6 and +10 and a b* value of between −4 and +24, or the transmitted color may have an a* value of between −5 and +8 and a b* value of between −3 and +18, or the transmitted color has an a* value of between −4 and +4, and a b* value of between −2 and +8.

In aspects, the variable transmittance layer may be variable between a non-opaque dark state and a light state; the variable transmittance layer may have a dark state reflectance spectrum when in the dark state and a different light state reflectance spectrum when in the light state; and the dark state reflectance spectrum and reflectance spectra for the color-balancing layers are selected such that in response to visible light incident on the reflectance color-balancing layer when the variable transmittance layer is in the dark state, a reflected color of the layered assembly has an a* value of between −10 and +22 and a b* value of between −9 and +9, or the reflected color has an a* value of between −4 and +19 and a b* value of between −5 and +6, or the reflected color has an a* value of between −2 and +15 and a b value of between −2 and +6.

In aspects of the invention, the variable transmittance layer is variable between a non-opaque dark state and a light state; the variable transmittance layer has a dark state reflectance spectrum when in the dark state and a different light state reflectance spectrum when in the light state; and the light state reflectance spectrum and reflectance spectra for the color-balancing layers are selected such that in response to visible light incident on the reflectance color-balancing layer when the variable transmittance layer is in the light state, a reflected color of the layered assembly has an a* value of between −10 and +23 and a b* value of between −2 and +22, or the reflected color has an a* value of between −6 and +18 and a b* value of between −2 and +16, or the reflected color has an a* value of between −2 and +16 and a b* value of between −2 and +12.

Thus, in one aspect, the invention relates to layered assemblies comprising a variable transmittance layer having opposing first and second sides; a reflectance color-balancing layer positioned on the first side of the variable transmittance layer; and a transmittance color-balancing layer positioned on the first side or second side of the variable transmittance layer. It is important to note that, in certain embodiments, the variable transmittance layer may be, for example, deposited directly on glass, for example an exterior glass of the vehicle. In this case, both the reflectance color-balancing layer and the transmittance color-balancing layer may be on the same side of the variable transmittance layer, preferably with the reflectance color-balancing layer nearest the viewer, that is the driver.

The invention provides, in one aspect, a multi-layer composition comprising a variable transmittance layer that may be a variable transmittance optical filter having at least a first transmission spectrum and a first reflection spectrum in a dark state, and a second transmission spectrum and second reflection spectrum in a faded state, and one or more color-balancing layers each having transmission and reflection spectra; each spectrum comprising a UV portion, a visible portion and an IR portion; and the spectra of the layers combining to provide a color of the multi-layer composition approximating a target transmitted color in the dark and light states, and a target reflected color in the dark and light states. The invention further provides, in an aspect, a laminated glass comprising such a multi-layer composition. The invention further provides, in an aspect, for an automotive glazing or architectural glazing, comprising the multi-layer composition or laminated glass. The multi-layer composition may further comprise one or more of a light attenuating layer, a UV blocking layer, and an IR blocking layer.

### DEFINITIONS AND TERMS

When we say that light or energy, whether visible, UV, or IR, is “blocked,” the term is intended to encompass the light absorbed and the light reflected, as well as any light within the wavelength range that is scattered by the optical product.

A spectrum refers to a characteristic light transmission or reflection of a multi-layer composition or component thereof, according to various aspects and embodiments. The transmitted light will typically have a UV, a visible and an IR component or portion. Spectra from various layers may be mathematically combined, and the visible region of the resulting spectrum may be described with reference to color (e.g. with L*a*b* values, RGB, or the like).

Variable transmittance layers, or variable transmittance optical filters, are layers that may adjust or alter the transmittance of electromagnetic radiation of any wavelength, whether UV, visible, or infrared, for example as a function of a material or physical stimulus. Physical stimulus would include mechanical, pressure, electromagnetic radiation, heat, chemical, or electrical.

As noted, these layers or filters may thus employ a variety of technologies to alter transmittance. Generally, such filters may be switched between a state of higher light transmittance (faded or light state) to a state of lower light transmittance (dark state) with the application, removal, or reduction of a stimulus such as UV light, temperature and/or a voltage. Examples of technology used in variable transmission windows include photochromics, electrochromics, polarimetry, thermochromics, chemochromics, liquid crystals, or suspended particles. Some photochromic materials may darken in response to light, for example ultraviolet light, and may return to a faded state when the UV light is removed or reduced. Some electrochromic materials may darken in response to application of a voltage, and may return to a faded state once the voltage is removed; alternately, some electrochromic materials may darken in response to application of a voltage of a first polarity, and fade when a voltage of an opposite polarity is applied. Some thermochromic materials may darken proportionately in response to a temperature increase—for example, the warmer the material, the darker it can become. The thermochromic material may return to a faded state when the temperature decreases. Liquid crystal materials and suspended particle devices comprise crystals or particles that alter orientation in response to application of a voltage. In the absence of a voltage, the liquid crystal molecules or particles are randomly oriented, and absorb or scatter incident light, thus appearing darker, lighter or opaque, or transmit very little light. When a voltage is applied, the liquid crystal molecules or particles are aligned with the electric field, and light may be absorbed to a different extent or transmitted. Where the variable transmittance optical filter includes an electrochromic aspect, the variable transmittance optical filter may comprise electrical connectors for connecting the optical filter to a control circuit, the control circuit to provide power to the optical filter to effect an electrochromic color change.

Variable transmittance optical filters or layers are thus optical filters that have different states of transmittance or transmission, such that the transmission can be in one state (e.g., a dark state) under a certain set of conditions, and a second state (e.g., a light state) under another set of conditions. Intermediate states can also be possible. Some examples of variable transmittance filters include electrochromic optical filters, as described in the prior art, photochromic optical filters, photochromic/electrochromic optical filters, suspended particle devices, liquid crystal devices, thermochromic optical filters, and others. According to some embodiments herein, the variable transmission optical filter is based on photochromic/electrochromic materials which darken when exposed to electromagnetic radiation (“light”) and fade when a voltage is applied to the material. Some photochromic/electrochromic materials may also fade when light of a selected wavelength is incident on the switching material.

The variable transmittance optical layers will typically provide the layered assemblies with desired or targeted transmitted colors that are approximately neutral. For example, the target transmitted color of the layered assembly in the dark state may have an a* value of between −13 and +13 and a b* value of between −20 and +3, or an a* value of between −10 and +10 and a b* value of between −15 and +3, or an a* value of between −4 and +4 and a b* value of between −7 and +3. Further, the target transmitted color in the light state may have an a* value of between −6 and +10 and a b* value of between −4 and +24, or an a* value of between −5 and +8 and a b* value of between −3 and +18, or an a* value of between −4 and +4 and a b* value of between −2 and +8.

When we describe the variable transmittance layers of the invention, or other layers described herein such as the color-balancing layers, as having opposing first and second sides, the numbering of these sides may be entirely arbitrary, unless the context clearly requires otherwise.

The one or more color-balancing layers of the invention will each have transmission and reflection spectra. These color-balancing layers are intended to balance the color of the layered assemblies, for example that arising from the variable transmittance layer. These color-balancing layers can be, for example, polymeric films such as PVB, or may be deposited on or incorporated into glass panes or polymeric films, if present in the assemblies or stacks of the invention. Thus, the reflectance color-balancing layer will desirably affect the reflected color of the layered assembly, while the transmittance color-balancing layer will desirably affect the transmitted color of the layered assemblies of the invention, as well as the color of objects illuminated by the light passing through the variable transmittance layer. It is understood that the reflectance color-balancing layer will be most effective at desirably affecting the reflected color of the layered assemblies of the invention when placed nearest the observer.

According to the invention, the layered assemblies of the invention may further exhibit a target reflected color in the dark state having an a* value of −10 to +22 and a b* value of −9 to +9, or an a* value of −4 to +19 and a b* value of −5 to +6, or an a* value of −2 to +15, and a b* value of −2 to +6. Further, the target reflected color in the light state may have an a* value of −10 to +23 and a b* value of −2 to +22, or an a* value of −6 to +18 and a b* value of −2 to +16, or an a* value of −2 to +16 and a b* value of −2 to +12.

In another aspect, the actual transmitted color compared with the target transmitted color may have a delta C of 20 or less, and the actual reflected color compared with the target transmitted color may also have a delta C of 20 or less.

In another aspect of the invention, the layered assemblies may have an LT_{A} of less than about 1%, or less than about 2% or less than about 5%, or less than about 10% in a dark state. Further, the layered assembly may have an LT_{A} of greater than about 5% or greater than about 10% or greater than about 15% or greater than about 20% in the faded state. In another aspect, the transmission haze through the layered assembly may be 5% or less, 3% or less, 2% or less, or 1% or less.

With respect to the variable transmittance layers described, it will be understood that these variable transmittance layers typically have at least a first and a second side, and that color-balancing layers will advantageously be positioned on one or the other of these sides. Thus, the reflectance color-balancing layer and the transmittance color-balancing layer can be on opposite sides or the same side of the variable transmittance layer. If the color-balancing layers are on the same side of the variable transmittance layer, either can be immediately adjacent the variable transmittance layer. One skilled in the art will understand, though, that the reflectance color-balancing layer is most effective when nearest the viewer, which may mean that it is placed on or functionally adjacent the transmittance color-balancing layer.

As used herein, the term “reflectance color-balancing layer” means a layer or element that causes reflected visible light of the layered assemblies to be closer to a target reflected color or spectrum, for example a target reflected color in the dark state having an a* value of −10 to +22 and a b* value of −9 to +9, or an a* value of −4 to +19 and an b* value of −5 to +6, or an a* value of −2 to +15 and a b* value of −2 to +6; and a target reflected color in the light state with an a* value of −10 to +23 and a b* value of −2 to +22, or an a* value of −6 to +18 and a b* value of −2 to +16, or an a* value of −2 to +16 and a b* value of −2 to +12.

As used herein, the term “transmittance color-balancing layer” means a layer or element that causes transmitted visible light to meet a target transmitted color or spectrum, for example a target transmitted color in the dark state having an a* value of between −13 and +13 and a b* value of between −20 and +3, or an a* value of between −10 and +10 and a b* value of between −15 and +3, or an a* value of between −4 and +4 and a b* value of between −7 and +3; and a target transmitted color in the light state having an a* value of between −6 and +10 and a b* value of between −4 and +24, or an a* value of between −5 and +8 and a b* value of between −3 and +18, or an a* value of between −4 and +4 and a b* value of between −2 and +8.

Those skilled in the art will understand that, when considering how to color-balance transmittance, both the view through the glazing, for example from inside a vehicle outwards, as well as the color effect on light transmitted through the glazing, should be considered.

The term ‘stack,’ or layered assembly, may be used generally to describe two or more layers (glass, interlayer, color-balancing layer, light attenuation layer, layer-by-layer coatings, adhesive layers or the like), through which light is transmitted or from which light is reflected, or more specifically, the layered assemblies of the invention. The stack may be described with reference to color, spectrum, transmitted light, reflected light, or a difference between the color or transmitted or reflected light of the stack, relative to a target (LT_{A}, L*a*b*, delta C, delta E or the like).

The term “mil” as used herein, refers to the unit of length for 1/1000 of an inch (0.001). One (1) mil is about 25 microns; such dimensions may be used to describe the thickness of an optical filter or components of an optical filter, according to some embodiments of the invention. One of skill in the art is able to interconvert a dimension in ‘mil’ to microns, and vice versa.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

The color of a switching material, layer, an multi-layer composition or a laminated glass comprising an multi-layer composition may be described with reference to color values L*a* and b* (in accordance with Illuminant D65, with a 10 degree observer), as is known in the art, and/or with reference to the visible light transmission LT_{A} (luminous transmission, Illuminant A, 2 degree observer) as is known in the art. LT_{A} and L*a*b* values may be measured in accordance with SAEJ1796 standard. The L*a*b color space provides a means for description of observed color. L* defines the luminosity where 0 is black and 100 is white, a* defines the level of green or red (where +a* values are red and −a* values are green), and b* defines the level of blue or yellow (where +b* values are yellow and −b* values are blue). For reference to neutral grays, the transmitted or reflected color may be described with no relation to L*, by calculating C (or C*ab) value, where C=(a²+b²)^{1/2}.

To describe a scalar relationship between a target color and the achieved color (from combining one or more layers with a variable transmittance optical filter), ΔC (delta C) is calculated:

delta C=C*_{ab} of stack−C*_{ab} of target.

To describe a vector relationship between a target color and the achieved color, ΔE (deltaE) is calculated:

delta E*_{ab}=[(delta L*)²+(delta a*)²+(delta b*)²]^{1/2}

As an example to illustrate the range of C values that may be considered to be neutral, transmission spectra from 10 commercial sources of ‘gray’ glass were obtained (normalized for LT_{A}), demonstrating a maximum C value (Cmax) of 4.4, with an average C value (Cavg) of 1.6, but with substantially similar reduction of LT_{A} across the entire visible spectrum. Other L*a*b* values over a range of gray tones are addressed below. Thus, a neutral color may be described as ‘achromatic’ (having a similar, or approximately similar LT_{A} over the visible range). Two or more spectra may be described as ‘complementary’ when they provide an achromatic spectrum (“neutral color”) when the visible portions of the spectra are combined. When judged “by eye”, a neutral color is not substantially yellow/blue or red/green. The lower the deltaC or deltaE value, the lesser the difference in color between the target color and the color of the stack. Generally, a stack approximating a target color will have a delta C of about zero to about 20, or any amount therebetween, or a delta E of about zero, or any amount therebetween. For clarity, a range of about zero to about 20 or any amount therebetween includes, about 1, 2, 3, 4, 5, 6, 7, 8, 9, 10, 11, 12, 13, 14, 15, 16, 17, 18 or 19, or any amount therebetween.

Directional terms such as “top”. “bottom”, “upwards”, “downwards”, “vertically”, “laterally”, “inboard” and “outboard” are used in this disclosure for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this disclosure are intended to include indirect and direct connections unless otherwise indicated. For example, if a first article is coupled to a second article, that coupling may be through a direct connection or through an indirect connection via another article.

Unless defined otherwise, all technical and scientific terms used herein have the same meaning as is commonly understood by one of ordinary skill in the art to which this invention belongs. If a definition set forth in this section is contrary to or otherwise inconsistent with a definition set forth in the documents that are herein incorporated by reference, the definition set forth herein prevails over the definition that is incorporated herein by reference.

### EXAMPLES

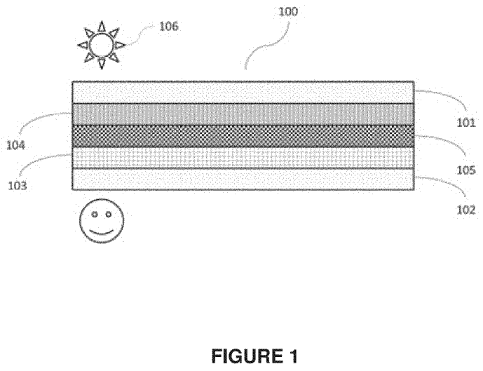

Generally, a window comprising a variable transmittance component (e.g. a variable transmittance optical filter, layer, or element, or a variable transmittance laminated glass or the like) may separate an interior space from an exterior space. Various layers, and various arrangements of layers may be contemplated depending on the components of the window. It may be desirable to alter the observed (reflected) color of the window, or the color of the transmitted light, to match or approximate a target color that is different from the color of the variable transmittance layer. For example, it may be desirable to match or approximate a target color to harmonize the appearance of the window with a building envelope or the exterior color of a vehicle, or to harmonize the appearance of the window with other components of the window such as the frame. FIGS. 1 to 6 provide various configurations and arrangement of the layers in a multi-layer composition that may be used for such windows. In some embodiments, the relative position of the layers may be described with reference to the variable transmittance layer and the incident light or a space defined in part by the window.

In an example of the current invention, FIG. 1 shows a multilayer stack according to the current invention comprising a laminated glass stack 100. The laminated stack comprises two layers of glass, 101 and 102, two layers of polyvinyl butyral (PVB), 103 and 104, and a variable transmittance layer 105. The PVB layer 103, which in this example also serves as a color-balancing layer, is inboard of a variable transmittance layer 105. In this example, PVB layer 103 would be closer to the interior space if this were part of a window installed in a building or vehicle. Similarly, PVB layer 104, which also serves as a color-balancing layer in this example, is outboard of the variable transmittance layer 105. Incident light from a light source 106 may be natural or simulated sunlight, or may be artificial light from any suitable source. The incident light may comprise the full visible spectra, and largely exclude light outside the visible spectra, or the incident light may comprise a UV and/or infrared/near infrared component.

A variable transmittance layer 105 comprises a variable transmittance optical filter, itself comprising a switching material (switchable material). According to an example, variable transmittance layer 105 comprises a photochromic/electrochromic switching material. Examples of variable transmittance optical filters are described in U.S. Pat. No. 8,441,707, WO2013/106921, the relevant portions of which are incorporated herein by reference in their entirety, to the extent they are not inconsistent with the present disclosure. Additional examples of switching material are described in U.S. Pat. No. 8,441,707, and in U.S. Ser. No. 10/054,835, the relevant portions of which are incorporated herein by reference in their entirety, to the extent they are not inconsistent with the present disclosure. The variable transmittance layer 105 may be any color in the faded or dark state. In some examples, the faded state will be substantially colorless, or faintly colored (e.g. some switching material comprising photochromic/electrochromic compounds are a pale yellow color in a faded state) and substantially colored in a dark state (e.g. some switching material comprising photochromic/electrochromic compounds are blue or blue-green, or pink/red or fuchsia in a dark state). Other switching materials or technologies such as electrochromics, photochromics, suspended particle devices, or liquid crystal-based technologies can also be used in place of the photochromic/electrochromic variable transmittance layer.

According to an example, the variable transmittance layer can be in the form of a sealed multi-layer plastic film, that can be then laminated between the two layers of glass, 101 and 102, using PVB layers 103 and 104. The variable transmittance can have a dark state and a light state, as well as states in between. The transmitted color or reflected color of the variable transmittance layer by itself may not be preferred for a specific application or customer. Where a neutral color of the multi-layer composition or laminated glass is desired, one or both of PVB layers 103 and 104 can be colored to alter the transmitted light and/or the reflected light.

In this example, PVB layer 103 is a plum-colored PVB, and PVB layer 104 is a light gray PVB. As described in some prior-art examples, the plum-colored PVB layer 103 can be used to color-balance an example of a photochromic/electrochomic variable transmittance filter 105 by altering the spectrum of the light transmitted through the laminated assembly to match a more neutral target color in the dark state and/or the light state. In a prior art example, a plum-colored PVB layer is placed outboard of the variable transmittance filter. This achieves the target of providing a transmitted color more closely approximating the target color but does not account for the reflected color of the laminated glass stack.

Experimentally, it has been found that reflected color as viewed from the outside is dominated by the color of the first layer inside the glass, or in some cases of the glass itself or layers on the glass. As such, the reflected color is dominated in the prior art example by the plum-colored PVB since it is placed outboard of the variable transmittance layer. The customer may require a more neutral reflected color. Referring back to FIG. 1, an example of a laminated glass stack 100 is shown that provides color-balance to a target transmitted color while at the same time providing a more neutral reflected color as viewed from the outside.

In the example shown in FIG. 1, the plum-colored PVB layer 103 is placed inboard of the variable-transmittance layer 105 and a second light gray PVB layer 104 outboard of the variable transmittance layer 105 and immediately inboard of the outside glass layer 101. The transmitted color is the same regardless of the position of plum-colored PVB layer 103 (whether outboard or inboard of the variable transmittance layer 105), but the reflected color as viewed from the outside is greatly improved (i.e., made more neutral) in this example by placing the plum-colored PVB layer 103 inboard of the variable transmittance layer 105 and by including a light gray-colored PVB layer 104 outboard of layer 105. A light-gray PVB layer used in this example can be a 15 mil thick PVB with a visible light transmittance of approximately 71%. The light-gray PVB layer 104 will reduce the overall amount of light transmittance through the stack, but depending on the customer an overall darker stack could be desired. If not, the stack could be made lighter by, for example, reducing the amount of switching material in the variable transmittance layer 105 and/or by increasing the light transmittance of the plum-colored PVB layer 103 (i.e., make it lighter), or other means.

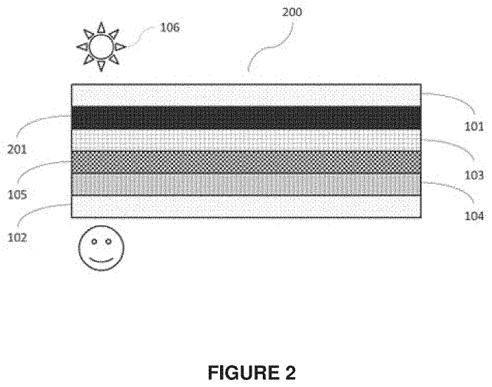

FIG. 2 shows a laminated glass stack 200 with a plum-colored PVB layer 103 outboard of the variable transmittance layer 105 and a light gray PVB layer 104 inboard of the variable transmittance layer 105. The plum-colored PVB 103 serves the same function of color-balancing the transmitted color of the variable-transmittance layer 105 in the dark and/or the light state. In order to achieve a desired reflected color, two gray-colored PVB layers are used. A light-gray PVB layer 104 is placed inboard of the variable transmittance layer 105 in order to make the reflected color of the glass laminated stack 200 appear more neutral from the inside. In order to make the reflected color of the glass laminated stack 200 appear more neutral from the outside, a dark gray PVB layer 201 is placed outboard of the plum-colored PVB layer 103. Since the dark gray PVB layer 201 is the first layer inside of glass layer 101, it has the greatest impact on the reflectance of the stack as viewed from the outside. In this example, a neutral reflected color is desired and the additional dark gray PVB layer 201 helps to achieve this target. The dark gray PVB layer 201 could be for example a 15 mil thick PVB layer with a visible light transmittance of about 43%.

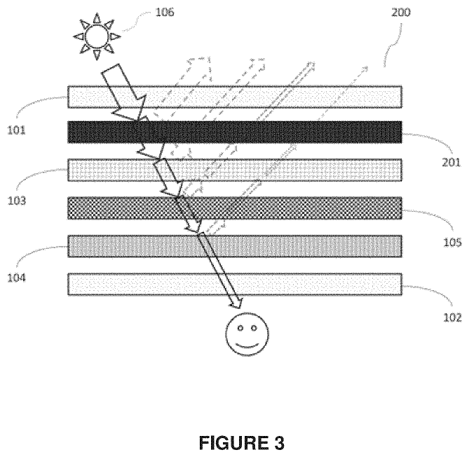

FIG. 3 shows how reflected light is affected by the various layers in the laminated glass stack 200 according to this example. The width of the arrows in FIG. 3 represents the light intensity. The largest portion of reflected light comes from the layer immediately beneath the outside glass layer 101. In this case, the dark gray PVB layer 201 reflects a neutral color, and because it is the closest layer to the glass, the neutral color that is reflected by this layer will tend to dominate the color of the total of the reflected light. As the light goes deeper into the stack, it has already been attenuated by the dark gray PVB layer 201 and so less light reflects off subsequent layers. In addition, the reflected light is further attenuated because it also has to travel back through the dark gray layer 201 to reach the outside. For example, the reflected layer from the plum-colored PVB layer 103 is very much reduced and affects the reflected color much less, and the light reflected from the variable transmission layer 105 is very much reduced. Light reflected from PVB layer 104 inboard of the variable transmission layer 105 is almost negligible. Note in this example that reflected light from the inside of the vehicle or building will also be more neutral since the light gray PVB layer 104 will dominate the reflection of the light from the inside of the multi-layer stack 201.

Although a particular PVB interlayer has just been described, a variety of interlayer materials may be used. Desirably, the interlayers will be colored to achieve the desired transmittance and reflection.

When the interlayers comprise PVB, the PVB resin may be produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B. E. Wade (2003), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in PVB refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual hydroxyl content and residual acetate content is measured on a weight percent (wt. %) basis per ASTM D1396.

The PVB resins of the present disclosure typically have a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

Although the embodiments described refer to the polymer resin as being PVB, it would be understood by one of ordinary skill in the art that the polymer may be any polymer suitable for use in a multiple layer panel. Typical polymers include, but are not limited to, polyvinyl acetals (PVA) (such as poly(vinyl butyral) (PVB) or isomeric poly(vinyl isobutyral) (PVisoB), polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomeric polymer PVisoB, polyvinyl chloride, and polyurethane are particularly useful polymers generally for interlayers; PVB (and its isomeric polymer) is particularly preferred.

In a further aspect, the diffusive interlayer can be a multilayered interlayer. For example, the multilayered interlayer can consist of PVB//PVisoB//PVB. Other example includes PVB//PVC//PVB or PVB//PU//PVB. Further examples include PVC//PVB//PVC or PU//PVB//PU. Alternatively, the skin and core layers may all be PVB using the same or different starting PVB resins.

At least one of the PVB layers will typically further comprise at least one colorant. One skilled in the art would further understand that multiple PVB layers having different colors may be combined, or separate colored layers of a plastic such as PET may be added or used in place of the PVB.

Alternatively, the PVB layer may be provided as an adhesive-coated plastic material applied to a plastic layer, as disclosed and claimed in U.S. Pat. Nos. 6,455,141 and 9,248,628, the disclosures of which are incorporated herein by reference in their entirety, to the extent they are not inconsistent with the present disclosure. In these aspects, an adhesive-coated plastic material may be used, for example in a laminate assembly.

According to this aspect, the coated plastic intermediate layer may be bonded to one of the glass sheets using a very thin (e.g. 0.25 to 5 mil) (0.006 mm to 0.127 mm) layer of adhesive that gives a highly planar texture to the coated plastic intermediate layer. This planarity is retained when this glass-sheet-adhesive-plastic film composite is incorporated into a final laminated glass structure using a second layer of adhesive and a second sheet of glass.

This product has a first glass sheet with a smooth first surface; a first adhesive layer affixing a plastic film to the smooth surface of the first glass sheet. This first adhesive layer is thin, that is less than 5 mils (0.127 mm) thick. The plastic film is registered and conformed to the smooth surface of the first glass sheet. The plastic film may carry an energy-reflective coating. The glass laminate is completed by a second adhesive layer bonding the plastic film to a second glass sheet. The energy-reflective layer can be on either side of the plastic film, but better results are achieved if it faces the thin adhesive layer and first glass sheet.

In another aspect this aspect provides an intermediate to the final product just described. This intermediate is a plastic film carrying the energy blocking layer and a 5 mil (0.127 mm) or less coating of adhesive on either side of the film but preferably on the side carrying the energy reflective layer where it provides a final product having greater stability and product life with improved corrosion resistance for the energy reflective layer.

In a further aspect, a method is provided for producing this intermediate in which an energy reflective layer coated plastic film is coated (preferably over the energy reflective coating) with a solution of an adhesive. Then the solvent is removed from the solution coating, leaving a layer of adhesive on the energy-reflective layer carrying plastic film. The thickness of the coating of adhesive solution may be predetermined to yield a final neat adhesive layer that is less than 5 mils (0.127 mm) thick.

This process can be part of an overall laminated window production scheme in which the adhesive-coated, reflective layer-carrying plastic film is adhered and conformed to a smooth surface of a first sheet of glass, a second layer of adhesive is applied followed by a second sheet of glass and the overall structure is laminated.

Further, the adhesive, that can be PVB, once applied to a plastic layer, may be grooved or textured to allow formerly trapped air to escape from between layers of a laminate assembly during a laminate process. This can allow for the adhesive layer to be thinner, while still providing for a final product that is relatively air bubble-free and optically pleasing or substantially free of optical defects caused by waviness of the plastic layer between two PVB sheets and/or wrinkles of the plastic sheet.

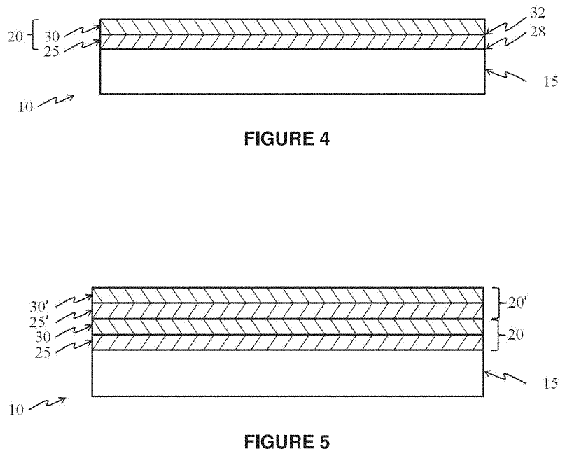

In an alternative embodiment, layer-by-layer techniques may be used to form one or more of the color-balancing layers, as disclosed and claimed, for example, in U.S. Pat. No. 9,453,949, incorporated herein by reference in its entirety. In this aspect, a color-balancing layer is formed, referring now to FIGS. 4 and 5, as an optical product 10 comprising a polymeric substrate 15 and a composite coating 20. The composite coating includes a first layer 25 and a second layer 30. Preferably first layer 25 is immediately adjacent to said polymeric substrate 20 at its first face 28 and second layer 30 is immediately adjacent to first layer 25 at its opposite face 32. This first layer 25 includes a polyionic binder while the second layer 30 includes an electromagnetic energy-absorbing insoluble particle. Each layer 25 and 30 includes a binding group component with the binding group component of the first layer and the binding group component of the second layer constituting a complementary binding group pair. As used herein, the phrase “complementary binding group pair” means that binding interactions, such as electrostatic binding, hydrogen bonding, Van der Waals interactions, hydrophobic interactions, and/or chemically induced covalent bonds are present between the binding group component of the first layer and the binding group component of the second layer of the composite coating. A “binding group component” is a chemical functionality that, in concert with a complementary binding group component, establishes one or more of the binding interactions described above. The components are complementary in the sense that binding interactions are created through their respective charges.

The first layer 25 of the composite coating may include a polyionic binder, which is defined as a macromolecule containing a plurality of either positive or negative charged moieties along the polymer backbone. Polyionic binders with positive charges are known as polycationic binders while those with negative charges are termed polyanionic binders. Also, it will be understood by one of ordinary skill that some polyionic binders can function as either a polycationic binder or a polyanionic binder depending on factors such as pH and are known as amphoteric. The charged moieties of the polyionic binder constitute the “binding group component” of the first layer.

Suitable polycationic binder examples include poly(allylamine hydrochloride), linear or branched poly(ethyleneimine), poly(diallyldimethylammonium chloride), macromolecules termed polyquatemiums or polyquats and various copolymers thereof. Blends of polycationic binders are also contemplated by the present invention. Suitable polyanionic anionic binder examples include carboxylic acid containing compounds such as poly(acrylic acid) and poly(methacrylic acid), as well as sulfonate containing compounds such as poly(styrene sulfonate) and various copolymers thereof. Blends of polyanionic binders are also contemplated by the present invention. Polyionic binders of both polycationic and polyanionic types are generally well known to those of ordinary skill in the art and are described for example in U.S. Published Patent Application number US20140079884 to Krogman et al. Examples of suitable polyanionic binders include polyacrylic acid (PAA), poly(styrene sulfonate) (PSS), poly(vinyl alcohol) or poly(vinylacetate) (PVA, PVAc), poly(vinyl sulfonic acid), carboxymethyl cellulose (CMC), polysilicic acid, poly(3,4-ethylenedioxythiophene) (PEDOT) and combinations thereof with other polymers (e.g. PEDOT:PSS), polysaccharides and copolymers of the above mentioned. Other examples of suitable polyanionic binders include trimethoxysilane functionalized PAA or PAH or biological molecules such as DNA, RNA or proteins. Examples of suitable polycationic binders include poly(diallyldimethylammonium chloride) (PDAC), Chitosan, poly(allyl amine hydrochloride) (PAH), polysaccharides, proteins, linear poly(ethyleneimine) (LPEI), branched poly(ethyleneimine) BPEI and copolymers of the above-mentioned, and the like. Examples of polyionic binders that can function as either polyanionic binders or polycationic binders include amphoteric polymers such as proteins and copolymers of the above mentioned polycationic and polyanionic binders.

The concentration of the polyionic binder in the first layer may be selected based in part on the molecular weight of its charged repeat unit but will typically be between 0.1 mM-100 mM, more preferably between 0.5 mM and 50 mM and most preferably between 1 and 20 mM based on the molecular weight of the charged repeat unit comprising the first layer. Preferably the polyionic binder is a polycation binder and more preferably the polycation binder is polyallylamine hydrochloride. Most preferably the polyionic binder is soluble in water and the composition used to form the first layer is an aqueous solution of polyionic binder. In an embodiment wherein the polyionic binder is a polycation and the first layer is formed from an aqueous solution, the pH of the aqueous solution is selected so that from 5 to 95%, preferably 25 to 75% and more preferably approximately half of the ionizable groups are protonated. Other optional ingredients in the first layer include biocides or shelf-life stabilizers.

The second layer 30 of the composite coating 20 may include an electromagnetic energy-absorbing insoluble particle. The phrase “electromagnetic energy-absorbing” means that the particle is purposefully selected as a component for the optical product for its preferential absorption at particular spectral wavelength(s) or wavelength ranges(s). The term “insoluble” is meant to reflect the fact that the particle does not substantially dissolve in the composition used to form the second layer 30 and exists as a particle in the optical product structure. The electromagnetic energy-absorbing insoluble particle is preferably a visible electromagnetic energy absorber, such as a pigment; however, insoluble particles such as UV absorbers or IR absorbers, or absorbers in various parts of the electromagnetic spectrum, that do not necessarily exhibit color may also be used. The electromagnetic energy-absorbing particle is preferably present in the second layer in an amount of from 30% to 60% by weight based on the total weight of the second layer. In order to achieve the desired final electromagnetic energy absorption level, the second layer should be formed from a composition that includes the insoluble electromagnetic energy-absorbing particle in the amount of 0.25 to 2 weight percent based on the total weight of the composition.

Pigments suitable for use as the electromagnetic energy-absorbing insoluble particle in a preferred embodiment of the second layer are preferably particulate pigments with an average particle diameter of between 5 and 300 nanometers, more preferably between 10 and 50 nanometers, often referred to in the art as nanoparticle pigments. Even more preferably, the surface of the pigment includes the binding group component of the second layer. Suitable pigments are available commercially as colloidally stable water dispersions from manufacturers such as Cabot, Clariant, DuPont, Dainippon and DeGussa. Particularly suitable pigments include those available from Cabot Corporation under the Cab-O-Jet® name, for example 250C (cyan), 265M (magenta), 270Y (yellow) or 352K (black). In order to be stable in water as a colloidal dispersion, the pigment particle surface is typically treated to impart ionizable character thereto and thereby provide the pigment with the desired binding group component on its surface. It will be understood by ordinary skill that commercially available pigments are sold in various forms such as suspensions, dispersions and the like, and care should be taken to evaluate the commercial form of the pigment and modify it as/if necessary to ensure its compatibility and performance with the optical product components, particularly in the embodiment wherein the pigment surface also functions as the binding group component of the second layer.

Multiple pigments may be utilized in the second layer to achieve a specific hue or shade or color in the final optical product; however, it will again be understood by ordinary skill that, should multiple pigments be used, they should be carefully selected to ensure their compatibility and performance both with each other and with the optical product components. This is particularly relevant in the embodiment wherein the pigment surface also functions as the binding group component of the second layer, as for example particulate pigments can exhibit different surface charge densities due to different chemical modifications that can impact compatibility.

Preferably the second layer of the composite coating further includes a screening agent. A “screening agent” is defined as an additive that promotes even and reproducible deposition of the second layer via improved dispersion of the electromagnetic energy-absorbing insoluble particle within the second layer by increasing ionic strength and reducing interparticle electrostatic repulsion. Screening agents are generally well known to those of ordinary skill in the art and are described for example in U.S. Published Patent Application number US20140079884 to Krogman et al. Sodium chloride is typically a preferred screening agent based on ingredient cost. The presence and concentration level of a screening agent may allow for higher loadings of the electromagnetic energy-absorbing insoluble particle such as those that may be desired in optical products with a lower transmission, and also may allow for customizable and carefully controllable loadings of the electromagnetic energy-absorbing insoluble particle to achieve customizable and carefully controllable optical product levels.

These layer-by-layer optical products may be comprised of a single pigment, or may be comprised of pigment blends such as disclosed and claimed in U.S. Pat. No. 9,817,166, the disclosure of which is incorporated herein by reference in its entirety. They may be used in place of, or in addition to, the colored PVB layers already described.

In more specific embodiments, layer-by-layer optical products may be used that exhibit a neutral reflection, such as those disclosed and claimed in U.S. Pat. Nos. 10,613,261 and 10,627,555, the disclosures of which are incorporated herein by reference in their entirety.

In one aspect, that disclosed in U.S. Pat. No. 10,613,261, these neutral reflection layer-by layer optical products may comprise a composite coating having multiple bilayers of a first layer and a second layer, each provided with a binding group component which together form a complementary binding group pair, the multiple bilayers comprising: at least one bilayer a) comprised of a first pigment or pigment blend that exhibits a color reflection value that is less than about 2.5; at least one bilayer b) comprised of a pigment or pigment blend that selectively blocks visible light in a wavelength range of interest; and at least one bilayer c) comprised of a second pigment or pigment blend that exhibits a color reflection value that is less than about 2.5, wherein the optical product selectively blocks visible light in the wavelength range of interest, while exhibiting a color reflection value that is less than about 2.5.

In this aspect, the wavelength range of interest may be, for example, a 75 nm wavelength range, or a 50 nm wavelength range, or as described elsewhere. Similarly, in various aspects, the wavelength range of interest may be from 400 nm to 450 nm, or from 600 nm to 650 nm, or from 500 nm to 600 nm, or from 525 nm to 575 nm, or as described elsewhere herein.

In this aspect, the optical products may further comprise at least one bilayer d), deposited on the at least one bilayer c), comprised of a pigment or pigment blend that, when formed into a bilayer, selectively blocks visible light in the wavelength range of interest, and that may be the same as or different than the pigment or pigment blend of bilayer b); and at least one bilayer e) comprised of a neutral pigment or pigment blend that, when formed into a bilayer, exhibits a color reflection value that is less than about 2.5, and that may be the same as or different than the pigment or pigment blend of bilayer a) or bilayer c).

In further embodiments of this aspect, the optical products may have a color reflection value of less than about 2.0, or less than about 1.5, or as described elsewhere herein. As noted, the substrate of these optical products may comprise a polyethylene terephthalate film, and separately, the composite coating may have a total thickness of from 5 nm to 1000 nm.

In another aspect, that disclosed in U.S. Pat. No. 10,627,555, these neutral reflection layer-by-layer optical products may comprise a composite coating, deposited on a substrate, provided with at least one bilayer having a first layer and a second layer, each provided with a binding group component which together form a complementary binding group pair. The at least one bilayer comprises a pigment blend that includes: a) at least two pigments that, when mixed together and formed into a bilayer, exhibit a color reflection value that is less than about 2.5; and b) one or more pigments that when mixed and formed into a bilayer selectively block visible light in a wavelength range of interest.

In this aspect also, the wavelength range of interest may be a 75 nm wavelength range, or a 50 nm wavelength range, or may be a wavelength range from 400 nm to 450 nm, or from 600 nm to 650 nm, or from 500 nm to 600 nm, or from 525 nm to 575 nm, or as described elsewhere herein.

In this aspect, the at least one bilayer of the optical products of the invention may comprise at least 3 bilayers, or as described elsewhere herein. In other aspects, the color reflection value of the optical products of the invention may be less than about 2.0, or less than about 1.5, or as described elsewhere herein.

In this aspect also, the optical products may comprise as a substrate a polyethylene terephthalate film. In another aspect, the composite coatings of the optical products of the invention may have a total thickness of 5 nm to 1000 nm, or as described elsewhere herein.

When we say that the optical products or films, or an individual bilayer or plurality of bilayers, of these neutral reflection layer-by-layer coatings selectively block visible light within a wavelength range of interest, or within a defined wavelength range, or a predetermined wavelength range, we mean that the amount of light blocked within that wavelength range is greater than the amount of light blocked at other wavelength ranges of the same width within the visible light spectrum, that is, approximately 400 nm to 700 nm, or as described elsewhere herein. When we say that the light is selectively blocked, the definition of “blocked” is intended to encompass the light absorbed and the light reflected, as well as any light within the wavelength range that is scattered by the optical product; that is, all light that is not transmitted through the film or optical product so that it can be measured is considered to be “blocked,” whether the light blocked is absorbed, reflected, or scattered. The wavelength of interest can, of course, be predetermined, and a pigment selected, for example, that absorbs light within that preselected or predetermined wavelength range. Conversely, the wavelength range of interest may be randomly selected, in the sense that pigments may be tried for novelty or esthetic effect and chosen based solely on appearance and their effect on transmitted color, so long as the desired relatively neutral reflection is also achieved, as defined by the color reflection value.

The light measurements, as used in these aspects described more fully in U.S. Pat. Nos. 10,613,261 and 10,627,555, the relevant portions of which are incorporated herein by reference in their entirety, to the extent they are not inconsistent with the present disclosure, are those determined using the 1976 CIE L*a*b* Color Space. CIE L*a*b* is an opponent color system based on the earlier (1942) system of Richard Hunter called L, a, b. In the CIE L*a*b* color space, the three coordinates represent: the lightness of the color (L*=0 yields black and L*=100 indicates diffuse white); its position between red and green (a*, negative values indicate green while positive values indicate red); and its position between yellow and blue (b*, negative values indicate blue and positive values indicate yellow).

These layer-by-layer optical products may thus be used to replace one or both of the colored PVB layers referred to above.

Performance of laminated glass or multi-layer compositions as described herein may be tested by conducting studies using standard techniques in the art, for example, measurement of VLT, LT_{A}, color, and haze. WO2010/142019 describes methods, equipment and techniques that may be used to assess the performance of optical filters.

Table 1 and Table 2 below show the color balance data for an example with the multi-layer glass laminated stack similar to that shown in FIG. 2 and FIG. 3, except that plum-colored PVB layer 103 is a plum-colored PET layer in this example. Table 1 shows the reflected L*,a*,b* and delta C numbers for when the variable transmittance layer 105 is in the dark state. Table 2 shows the reflected L*,a*,b* and delta C numbers for when the variable transmittance layer 105 is in the light state. Table 3 shows the transmitted L*,a*,b* values, delta C numbers and LT_{A} values for when the variable transmittance layer 105 is in the dark state. Table 4 shows the transmitted L*,a*,b* values, delta C numbers and LT_{A} values for when the variable transmittance layer 105 is in the light state. Values for different combinations of neutral gray PVB layers (layers 104 and 201) are shown. The percentage numbers shown across the top row are a measure of the amount of black pigment in layer 201 (first number) and layer 104 (second number), where a value of 100% roughly corresponds to a desired total loading of black pigments split between layers 104 and 201. In all of the devices tested, the plum-colored PET layer 103 remains the same. The plum-color PET is included in the stack to ensure the transmitted color approximates a transmitted color target. Data for reflected color L*,a*,b* values and delta C numbers are shown for the stack when viewed from both the top (outside; most outboard position) and bottom (inside; most inboard position) of the stack.

In this example, both the target reflected and transmitted colors are completely neutral colors, with a* and b* values of 0. Perfectly matching this target reflected and transmitted colors would result in a delta C of zero. However, as discussed previously, a delta C of between 0 and 20 indicates a good approximation to the target color and would be acceptable in most applications. As can be seen in Table 1, it is possible even with the variable transmittance filter 105 in the dark (most colored) state to achieve delta C values of less than 20 in reflected color from the outside through addition of the gray PVB layer 201 and also from the inside through addition of the gray PVB layer 104. Without these gray layers the delta C values for reflected light from both the outside and the inside would be much higher.

Note from Table 1 that in general, the darker the gray (the higher the percentage of black pigments) the more effective it is in dominating the reflected color and reducing the delta C value. For example, the delta C of the reflected light from the top with gray PVB layer containing 55% of the total black pigments (PVB layer 201 in FIGS. 2 and 3) is 4.6 as shown in Example 1, which is higher than the delta C value of 1.4 achieved by the same stack with a darker (90% of black pigments) gray PVB layer in Example 4. Note that a clear trend exists across Examples 1-4; the higher the percentage of black pigments in the gray PVB layer, the lower the delta C value (more neutral). In all of these examples, color filters can be commercially available filters, or they could be custom filters designed to transmit and reflect a particular spectrum to match a desired application or to more optimally work with a particular variable transmittance filter.

TABLE 1
Reflection color coordinate and delta C values with
variable transmittance filter in the dark state

| | Black pigment loading of gray layers 104/201 (inboard/outboard), | | | |
|---|---|---|---|---|
| | expressed as a percentage, where 100% is approximately the | | | |
| | desired total loading to be split between the two gray layers | | | |
| | Example 1 | Example 2 | Example 3 | Example 4 |
| | 55%/45% | 67%/33% | 90%/15% | 90%/10% |
| Top L*, a*, b* | 28.9, 4.5, 0.8 | 28.2, 2.7, 0.5 | 26.8, 0.2, 1.0 | 26.7, −0.2, 1.4 |
| Top delta C | 4.6 | 2.7 | 1.0 | 1.4 |
| Bottom | 29.7, 5.0, 1.8 | 30.1, 7.2, 4.5 | 35.0, 11.6, 6.5 | 37.3, 13.7, 8.8 |
| L*, a*, b* | | | | |
| Bottom delta C | 5.3 | 8.5 | 13.3 | 16.3 |

In Table 1, the delta C values of the light reflected from the bottom (inside; most inboard position) of the stack are also all below 20, so the reflected light from the bottom also approximates a neutral color target quite well. The delta C numbers also show a similar trend of increasing with lighter gray layers used as the PVB layer 104 directly beside the glass facing the inside (102). With the 45% black pigments loading in Example 1, a delta C of 5.3 is achieved, whereas the 10% black pigments loading in Example 4 results in a delta C of 16.3.

Variable transmittance filters have both a dark state and a light state with different light transmittance and color properties, so it can be important in some applications to ensure the reflected color approximates a target color well when the variable transmittance filter is in both the dark state and the light state. Table 2 below shows the reflected L*a*b* and delta C values for the same four examples with the variable transmittance filter in the light state. The delta C values are generally higher with the variable transmittance filter in the light state, showing that the light state reflected color is slightly more difficult to color balance than the dark state reflected color. However, almost all of the delta C values are still below 20, showing a good approximation to the target. The only delta C value that is slightly above 20 shows up in the bottom reflected value for Example 4 with an inboard gray-PVB layer that has a 10% black pigments loading, suggesting that a slightly darker gray PVB would help to make the reflected light more neutral in this Case.

TABLE 2
Reflection color coordinate and delta C values with
variable transmittance filter in faded state

| | Black pigment loading of gray layers 104/201 (inboard/outboard), | | | |
|---|---|---|---|---|
| | expressed as a percentage, where 100% is approximately the | | | |
| | desired total loading to be split between the two gray layers | | | |
| | Example 1 | Example 2 | Example 3 | Example 4 |
| | 55%/45% | 67%/33% | 90%/15% | 90%/10% |
| Top L*, a*, b* | 30.0, 7.0, 1.6 | 29.2, 5.3, 0.8 | 27.3, 2.0, 1.1 | 27.3, 1.8, 1.6 |
| Top delta C | 7.2 | 5.4 | 2.2 | 2.4 |
| Bottom | 31.9, 7.4, 3.0 | 33.5, 10.3, 6.4 | 40.5, 14.0, 10.1 | 43.8, 15.3, 13.7 |
| L*, a*, b* | | | | |
| Bottom delta C | 7.9 | 12.1 | 17.2 | 20.5 |

Table 2 shows delta C values calculated for when the target transmitted and target reflected light is a perfect neutral gray, which means a* and b* values of zero, and is represented by the origin in the a*b* color wheel. However, it is possible to set the transmitted and reflected target color within a range close to the origin of the a*b* color wheel and still achieve a neutral appearance, even with non-zero a* and b* values. In different applications, different regions of the color wheel close to the neutral origin may be preferred (e.g., a slight blue tint may be perceived to be more acceptable than a slight orange tint), and there may also be different targets for when the variable transmittance filter layer 105 is in the dark state vs. the light state.

TABLE 3
Transmitted color, delta C and LT_{A} values with
variable transmittance filter in the dark state

| | Black pigment loading of gray layers 104/201 (inboard/outboard), | | | |
|---|---|---|---|---|
| | expressed as a percentage, where 100% is approximately the | | | |
| | desired total loading to be split between the two gray layers | | | |
| | Example 1 | Example 2 | Example 3 | Example 4 |
| | 55%/45% | 67%/33% | 90%/15% | 90%/10% |
| L*, a*, b* | 2.0, −2.2, −6.0 | 2.2, −3.0, −6.2 | 2.8, −3.7, −5.7 | 2.5, −3.0, −6.3 |
| Delta C | 6.4 | 6.9 | 6.8 | 7.0 |
| LT_{A} | 0.1% | 0.1% | 0.2% | 0.2% |

Tables 3 and 4 show that the plum-colored PET layer 103 is effective in neutralizing the transmitted color for the same series of test devices (Examples 1-4), demonstrating that a target transmitted color in a faded state and a dark state can be achieved, while tandemly providing a target reflective color in a faded state and dark state from both the top (outside; most outboard position) and bottom (inside; most inboard position) of the stack. When the variable transmittance filter 105 is in the dark state (Table 3) the delta C values are 7 or lower indicating that the actual color closely approximates the target color. Similarly, when the variable transmittance filter 105 is in the light state (Table 4) the delta C values are below 20 indicating that the actual color approximates the target color as well. Note that in Examples 1, 2 and 4 the same loading of black pigments are present in gray PVB layers 201 and 104 combined (100%) and the plum-colored PET layer is also the same, which is why the transmitted color coordinates and LT_{A} values are very similar when the variable transmittance filter 105 is in either the dark state or the light state.

TABLE 4
Transmitted color, delta C and LT_{A} values with variable
transmittance filter in the light state

| | Black pigment loading of gray layers 104/201 (inboard/outboard), | | | |
|---|---|---|---|---|
| | expressed as a percentage, where 100% is approximately the | | | |
| | desired total loading to be split between the two gray layers | | | |
| | Example 1 | Example 2 | Example 3 | Example 4 |
| | 55%/45% | 67%/33% | 90%/15% | 90%/10% |
| L*, a*, b* | 23.3, 3.7, 18.2 | 23.0, 3.6, 17.9 | 21.5, 4.5, 17.1 | 22.7, 4.6, 17.9 |
| Delta C | 18.6 | 18.2 | 17.7 | 18.4 |
| LT_{A} | 4.3% | 4.2% | 3.8% | 4.2% |

### Example Target Color Ranges for Transmission of Light Through a Multi-Layer Stack

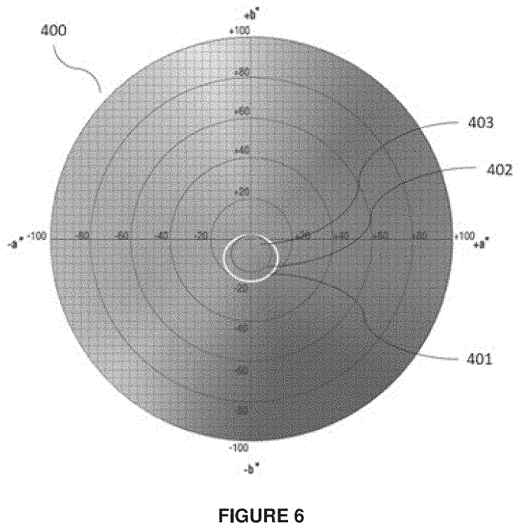

FIG. 6 shows an a*b* color wheel 400 with example target transmitted color ranges when the variable transmittance filter is in the dark state. In this example, the circle 401 represents a* values from −13 to +13, b* values from −20 to +3, and is a preferred color range for the transmitted color target. The circle 402 represents a* values from −10 to +10 and b* values from −15 to +3 and is a more preferred range for the transmitted color target. The circle 403 is a most preferred range, and represents a* values of −4 to +4, and b* values of −7 to +3.

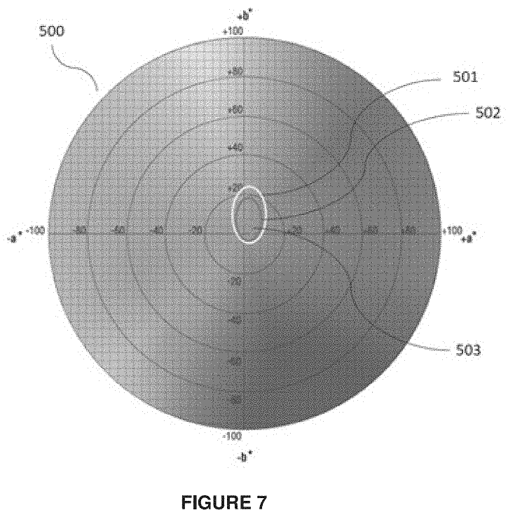

Similarly, FIG. 7 shows the a*b* color wheel 500 with example target transmitted color ranges when the variable transmittance filter is in the light state. In this example, the circle 501 represents a* values from −6 to +10, b* values from −4 to +24, and is a preferred color range for the transmitted color target. The circle 502 represents a* values from −5 to +8 and b* values from −3 to +18 and is a more preferred range for the transmitted color target. The circle 503 is a most preferred range, and represents a* values of −4 to +4, and b* values of −2 to +8.

### Example Target Color Ranges for Reflectance of Light from a Multi-Layer Stack

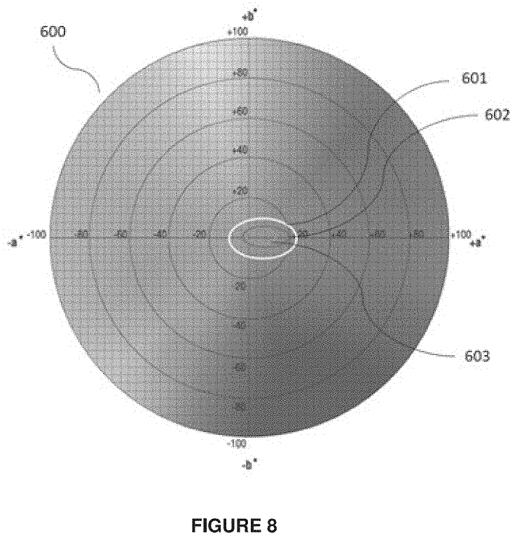

FIG. 8 shows the a*b* color wheel 400 with example target reflected color ranges when the variable transmittance filter is in the dark state. In this example, the circle 601 represents a values from −10 to +22, b values from −9 to +9, and is a preferred color range for the reflected color target. The circle 602 represents a* values from −4 to +19 and b* values from −5 to +6 and is a more preferred range for the transmitted color target. The circle 603 is a most preferred range, and represents a* values of −2 to +15, and b* values of −2 to +6.

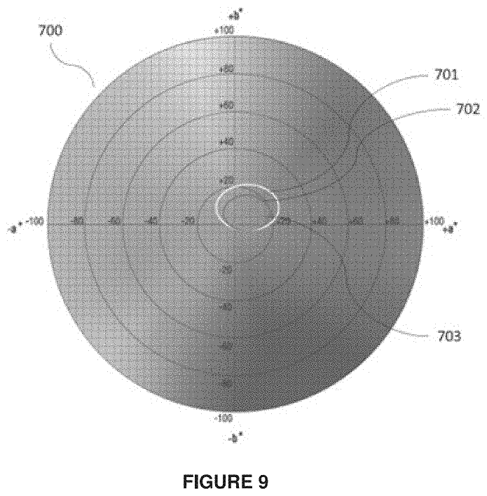

Similarly, FIG. 9 shows the a*b* color wheel 400 with example target reflected color ranges when the variable transmittance filter is in the light state. In this example, the circle 701 represents a* values from −10 to +23, b* values from −2 to +22, and is a preferred color range for the transmitted color target. The circle 702 represents a* values from −6 to +18 and b* values from −2 to +16 and is a more preferred range for the transmitted color target. The circle 703 is a most preferred range, and represents a* values of −2 to +16, and b* values of −2 to +12.

In an example, a multi-layer stack for which a neutral color is desired in both transmission and reflection has a delta C of 20 or less when the target color falls within the preferred range for both transmission and reflection for either the dark state, the light state, or for both states. In another example, the multi-layer stack has a delta C of 20 or less when the target color falls within the more preferred range for both transmission and reflection for either the dark state, the light state, or for both states. In another example, the multi-layer stack has a delta C of 20 or less when the target color falls within the most preferred range for both transmission and reflection for either the dark state, the light state, or for both states.

The above examples describe a target color ranges for achieving a more neutral transmitted and reflected light in a multilayer stack comprising a variable transmittance filter. However, according to other examples, the target color for transmission and/or reflection does not necessarily have to be a neutral color. For example, a designer of a vehicle may wish to match the reflected color to the brightly-colored paint of an automobile, or an architect may wish to design a building to reflect a certain target color of light.

In these examples, the multi-layer stack may contain colors other than plum for the transmitted-light color-balancing layer, or gray for the reflected-light color-balancing layers. The goal in these examples remains the same, which is to simultaneously achieve a transmitted color that has a delta C of 20 or less away from the target transmitted color, whatever that may be, and a delta C of 20 or less away from the target reflected color, whatever that may be for the particular application. It may not be possible to achieve a delta C of 20 or less for all combinations of transmitted color targets and reflected color targets, but the same general principles apply, which is to use a color layer that reflects the desired color as close to the outside pane of glass as possible outboard of the variable transmittance filter, and to use a color layer for balancing the transmitted color underneath this layer.

According to some examples, the multi-layer stack may have an LT_{A} of less than about 1%, or less than about 2% or less than about 5% or less than about 10% in a dark state. According to some examples the multi-layer stack may have an LT_{A} of greater than about 4% or greater than about 5% or greater than about 10% or greater than about 15% or greater than about 20% in the faded state.

According to some examples, the multi-layer stack may have an LT_{A} of from about 1% to about 10%, or any amount or range therebetween in the dark state, and an LT_{A} of from about 5% to about 30% in the faded state, or any amounts or ranges therebetween. For example, the multi-layer composition or laminated glass may have an LT_{A} in a dark or faded state of about 1, 2, 3, 4, 5, 6, 7, 8, 9, 10, 12, 14, 16, 18, 20, 25 or 30%, or any amount or range therebetween, with the proviso that the dark state has a lesser LT_{A} than the faded state. Where the target transmitted and reflected color is a neutral colored ‘stack’, a multi-layer stack according to various embodiments may have, in a faded state, an L* value of about 40 to about 60 or any amount therebetween.

The lamination of the multi-layer stack using PVB as in FIGS. 1, 2, and 3 can be accomplished using standard PVB lamination processes by applying heat and pressure to the stack (for example, in an autoclave) for a fixed period of time such that the PVB flows and bonds to both the variable transmission layer 105 and the glass layers 101 and 102. In this example, PVB layers are shown because using PVB is one of the most common materials for laminating glass, but other types of laminating layers can be used instead of the PVB for bonding the stack together. For example, ethylene-vinyl acetate (EVA), thermoplastic polyurethane (TPU), SentryGlas® ionoplast polymer interlayers, and various pressure sensitive adhesives (PSAs) are all examples of materials that can be used to bond glass to glass as well as film to glass that could also be easily pigmented or dyed to give them the appropriate color to achieve the current invention.

Color is also not necessarily included just in the PVB layers. It may alternatively or in addition be provided in the layer-by-layer optical products already described, typically deposited on a substrate such as PET. In a further aspect, one or more colored PET layers, for example dyed PET film, may be used to color the layered assemblies of the present invention.

It is also possible to use gray glass instead of gray PVB, or more generally, a colored glass instead of a colored polymer. For example, if the glass layer 101 in FIG. 3 was replaced with a gray glass instead of clear glass, the gray PVB layer 201 would no longer be necessary, or could be replaced with a clear PVB. The gray glass could be used in place of the gray PVB in order to achieve a target reflected color. Similarly, gray PVB layer 104 could also be replaced with a clear PVB layer if gray glass is used for glass layer 102.

Alternatively, the color-balance layers for transmittance and reflectance in the stack could be made up of materials other than PVB. In some examples, the colored layers could be polyethylene terephthalate (PET) layers adhered to the variable transmittance layer using pressure sensitive adhesives, and then the whole stack could be bonded to the glass using PVB or other materials. The pressure-sensitive adhesives layers themselves could also be colored, as well as the PET substrates that carry the transparent conductive electrodes in some examples of variable transmittance layers. Other films such as polyethylene naphthalate (PEN), polycarbonate, or thin glass films are also possible. In some examples, some of these layers can be flexible or rigid. The reflective color-balancing gray layers could also be a coating on the outside glass layers, that could be applied by sputtering, chemical vapour deposition, spray, slot die, painting, or other methods known in the art.

Low haze can be a desirable feature in some applications. In an example, the multi-layer stack has a total transmitted haze of about 5% or less, about 3% or less, about 2% or less, about 1.5% or less, or about 1% or less, or from about 0 to 2%, or from about 0.5% to about 3%, or any amount or range therebetween.

The color balance layers may also include UV adsorbers creating a UV cutoff wavelength, and/or UV stabilizers, or additional layers with these materials may be added to the stack. For example, adhesive layers such as PVB may have additives that block UV (e.g. U.S. Pat. No. 6,627,318). In an example, UV blocking materials are placed outboard of the variable transmittance filter layer 105 in order to prevent damaging UV from reaching the variable transmittance layer. For example, the gray PVB layer 201 could also include UV absorbers that cut off the UV below wavelengths of 380 nm or 400 nm.

One or more layers may also comprise an IR-blocking component. For example, a solar control film may be included in the multi-layer stack or laminated glass. Examples of such films include US 2004/0032658 and U.S. Pat. No. 4,368,945, the disclosures of which are incorporated herein by reference to the extent not inconsistent with the present disclosure. Alternatively, IR blocking materials may be incorporated into a layer of glass, or an adhesive layer. An IR blocking layer may reflect or absorb IR light. In an example, a layer of IR reflecting material is positioned outbound of the variable transmittance layer 105 in order to keep the stack cooler by reflecting the heat energy in the IR out of the stack before it passes through and is absorbed by other layers in the stack.

The multi-layer stack may also include a low emissivity (low E) coating. In an example, the low E coating is located inboard of the variable transmittance layer 105, on one of the surfaces of glass layer 102. This positioning of the layer helps to prevent radiation of heat from the multi-layer stack into the vehicle or building.

### OTHER EMBODIMENTS

It is contemplated that any embodiment discussed in this specification can be implemented or combined with respect to any other embodiment, method, composition or aspect, and vice versa.

The present invention has been described with regard to one or more embodiments. However, it will be apparent to persons skilled in the art that a number of variations and modifications can be made without departing from the scope of the invention as defined in the claims. Therefore, although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The terms “approximately” and “about” when used in conjunction with a value mean+/−10% of that value. In the specification, the word “comprising” is used as an open-ended term, substantially equivalent to the phrase “including, but not limited to,” and the word “comprises” has a corresponding meaning. As used herein, the singular forms “a”, “an” and “the” include plural referents unless the context clearly dictates otherwise. Citation of references herein shall not be construed as an admission that such references are prior art to the present invention, nor as any admission as to the contents or date of the references. All publications are incorporated herein by reference as if each individual publication was specifically and individually indicated to be incorporated by reference herein and as though fully set forth herein. The invention includes all embodiments and variations substantially as hereinbefore described and with reference to the examples and drawings.

1. A layered assembly comprising:
i. a variable transmittance layer having opposing first and second sides;
ii. at least a first reflectance color-balancing layer positioned on the first side of the variable transmittance layer; and
iii. a transmittance color-balancing layer positioned on the first side or second side of the variable transmittance layer.

2. The layered assembly of claim 1, further comprising a second reflectance color-balancing layer on a side of the variable transmittance layer opposite the first reflectance color-balancing layer.

3. The layered assembly of claim 1, wherein at least one of the first reflectance color-balancing layer and the transmittance color-balancing layer comprises a plurality of colored films.

4. The layered assembly of claim 1, further comprising a first polymer layer on a first side of the layered assembly, and a second polymer layer on a second side of the layered assembly.

5. The layered assembly of claim 4, wherein at least one of the first and second polymer layers comprises a PVB coating on PET.

6. The layered assembly of claim 1, wherein the layered assembly further comprises an IR-blocking layer.

7. The layered assembly of claim 1, wherein at least the first reflectance color-balancing layer comprises a colored PVB, and wherein the layered assembly further comprises a rigid substrate laminated to the first reflectance color-balancing layer.

8. The layered assembly of claim 2, wherein both the first reflectance color-balancing layer and the second reflectance color-balancing layer comprise a colored PVB, and wherein the layered assembly further comprises rigid substrates respectively laminated to the first reflectance color-balancing layer and the second reflectance color-balancing layer.

9. The layered assembly of claim 1, further comprising a polymer-based layer within which the variable transmittance layer, the reflectance color-balancing layer, and the transmittance color-balancing layer are laminated, wherein the reflectance color-balancing layer is immediately adjacent the polymer-based layer.

10. The layered assembly of claim 4, further comprising rigid substrates respectively laminated to the first polymer layer and the second polymer layer.

11. The layered assembly of claim 9, further comprising rigid substrates respectively laminated to opposing sides of the polymer-based layer.

12. The layered assembly of claim 1, wherein:
i. the variable transmittance layer is variable between a dark state and a light state;
ii. the variable transmittance layer has a dark state transmittance spectrum when in the dark state and a different light state transmittance spectrum when in the light state; and
iii. the dark state transmittance spectrum and transmittance spectra for the color-balancing layers are selected such that in response to visible light incident on the reflectance color-balancing layer when the variable transmittance layer is in the dark state, a transmitted color of the layered assembly approximates a target transmittance color, and a reflected color of the layered assembly approximates a target reflected color.

13. The layered assembly of claim 1, wherein:
i. the variable transmittance layer is variable between a dark state and a light state;
ii. the variable transmittance layer has a dark state transmittance spectrum when in the dark state and a different light state transmittance spectrum when in the light state; and
iii. the light state transmittance spectrum and transmittance spectra for the color-balancing layers are selected such that in response to visible light incident on the reflectance color-balancing layer when the variable transmittance layer is in the light state, a transmitted color of the layered assembly approximates a target transmittance color, and a reflected color of the layered assembly approximates a target reflected color.

14. The layered assembly of claim 12, wherein the target transmitted color in the dark state has an a* value of between −13 and +13 and a b* value of between −20 and +3, or an a* value of between −10 and +10 and a b* value of between −15 and +3, or an a* value of between −4 and +4 and a b* value of between −7 and +3.

15. The layered assembly of claim 13, wherein the target transmitted color in the light state has an a* value of between −6 and +10 and a b* value of between −4 and +24, or an a* value of between −5 and +8 and a b* value of between −3 and +18, or an a* value of between −4 and +4 and a b* value of between −2 and +8.

16. The layered assembly of claim 12, wherein the target reflected color in the dark state has an a* value of −10 to +22 and a b* value of −9 to +9, or an a* value of −4 to +19 and an b* value of −5 to +6, or an a* value of −2 to +15, and a b* value of −2 to +6.

17. The layered assembly of claim 13, wherein the target reflected color in the light state has an a* value of −10 to +23 and a b* value of −2 to +22, or an a* value of −6 to +18 and an b* value of −2 to +16, or an a* value of −2 to +16, and a b* value of −2 to +12.

18. The layered assembly of claim 12, wherein a difference between an actual transmitted color compared with a transmittance of a layered assembly in the absence of the first reflectance color-balancing layer and the transmittance color-balancing layer has a delta C of at least 5.

19. The layered assembly of claim 1, wherein the variable transmittance layer comprises one or more of a photochromic material, an electrochromic material, a thermochromic material, a liquid crystal material, or a suspended particle device.

20. The layered assembly of claim 1, wherein the variable transmittance layer is transitionable from a faded state to a dark state when exposed to electromagnetic radiation, and from a dark state to a faded state with the application of a voltage.

21. The layered assembly of claim 1, wherein the layered assembly has an LT_{A} of less than about 1%, or less than about 2% or less than about 5%, or less than about 10% in a dark state.

22. The layered assembly of claim 1, wherein the layered assembly has an LT_{A} of greater than about 5% or greater than about 10% or greater than about 15% or greater than about 20% in a faded state.

23. The layered assembly of claim 1, wherein the transmission haze through the layered assembly is 5% or less, 3% or less, 2% or less, or 1% or less.

24. The layered assembly of claim 1, wherein at least one of the reflectance color-balancing layer and the transmittance color-balancing layer comprises a layer-by-layer optical product comprising:
a. a polymeric substrate, and
b. a composite coating, said composite coating comprising a first layer comprising a polyionic binder and a second layer comprising a electromagnetic energy-absorbing insoluble particle, wherein each of said first layer and said second layer include a binding group component which together form a complimentary binding group pair.

25. A layered assembly, comprising:
i. a variable transmittance layer having opposing first and second sides;
ii. a transmittance color-balancing layer positioned on the first side of the variable transmittance layer;
iii. a first reflectance color-balancing layer positioned on the first side of the variable transmittance layer and outboard the transmittance color-balancing layer; and
iv. a second reflectance color-balancing layer positioned on the second side of the variable transmittance layer.

26. The layered assembly of claim 25, wherein:
i. the variable transmittance layer is variable between a dark state and a light state;
ii. the variable transmittance layer has a dark state transmittance spectrum when in the dark state and a different light state transmittance spectrum when in the light state; and
iii. the dark state transmittance spectrum and transmittance spectra for the color-balancing layers are selected such that in response to visible light incident on the reflectance color-balancing layer when the variable transmittance layer is in the dark state, a transmitted color of the layered assembly has an a* value of between −13 and +13 and a b* value of between −20 and +3.

27. The layered assembly of claim 25, wherein:
i. the variable transmittance layer is variable between a dark state and a light state;
ii. the variable transmittance layer has a dark state transmittance spectrum when in the dark state and a different light state transmittance spectrum when in the light state; and
iii. the light state transmittance spectrum and transmittance spectra for the color-balancing layers are selected such that in response to visible light incident on the reflectance color-balancing layer when the variable transmittance layer is in the light state, a transmitted color of the layered assembly has an a* value of between −6 and +10 and a b* value of between −4 and +24, or an a* value of between −5 and +8 and a b* value of between −3 and +18, or an a* value of between −4 and +4 and a b* value of between −2 and +8.

28. The layered assembly of claim 26, wherein:
i. the variable transmittance layer is variable between a non-opaque dark state and a light state;
ii. the variable transmittance layer has a dark state reflectance spectrum when in the dark state and a different light state reflectance spectrum when in the light state; and
iii. the dark state reflectance spectrum and reflectance spectra for the color-balancing layers are selected such that in response to visible light incident on the reflectance color-balancing layer when the variable transmittance layer is in the dark state, a reflected color of the layered assembly has an a* value of between −10 and +22 and a b* value of between −9 and +9.

29. The layered assembly of claim 26, wherein:
i. the variable transmittance layer is variable between a non-opaque dark state and a light state;
ii. the variable transmittance layer has a dark state reflectance spectrum when in the dark state and a different light state reflectance spectrum when in the light state; and
iii. the light state reflectance spectrum and reflectance spectra for the color-balancing layers are selected such that in response to visible light incident on the reflectance color-balancing layer when the variable transmittance layer is in the light state, a reflected color of the layered assembly has an a* value of between −10 and +23 and a b* value of between −2 and +22.
